(19) United States
(12) Patent Application Publication
(10) Pub. No.: US 2025/0002220 A1
(43) Pub. Date: Jan. 2, 2025

(54) PAPER PACKAGE AND A METHOD FOR MAKING A PAPER PACKAGE

(71) Applicant: CREAMILL OY, Tampere (FI)

(72) Inventors: Carl-Erik GUTTORMSEN, Kotka (FI); Matti KOSKINEN, Tampere (FI)

(73) Assignee: CREAMILL OY, Tampere (FI)

(21) Appl. No.: 18/576,626

(22) PCT Filed: Jul. 1, 2022
(86) PCT No.: PCT/FI2022/050484

§ 371 Date: Jan. 4, 2024

(30) Foreign Application Priority Data
Jul. 5, 2021 (FI) U20214076

(51) Int. Cl. B65D 33/18; B31B 70/00; B31B 70/60; B31B 70/62; B31B 70/64; B31B 160/30; B65D 30/00; B65D 33/00

(52) U.S. Cl. CPC B65D 33/18; B31B 70/004; B31B 70/61; B31B 70/62; B31B 70/64; B65D 31/00; B65D 33/007; B31B 2160/30

(57) ABSTRACT

A package made of fibre material has at least a first wall and a second wall, as well as an adhesive stripe between the first wall and the second wall. The adhesive stripe constitutes a seam closing the package on that side of the package where the package is arranged to be opened. The paper package further has at least one fibre rip stopper at the edge of the adhesive stripe or at a distance from it in the direction of the interior of the package, the stopper being arranged to delimit the point separating the first wall and the second wall to the edge of the adhesive stripe or to a distance from it in the direction of the interior of the package when the package is opened. The disclosed embodiments also relates to a method for making a package of fibre material.

### FIELD

The aspects of the disclosed embodiments relate to a paper package comprising at least a first package wall and a second package wall, as well as an adhesive stripe between the first wall and the second wall, the adhesive stripe forming a seam sealing the package. The aspects of the disclosed embodiments also relate to a method for making a paper package.

### BACKGROUND

Conventionally, paper packages are sealed with an adhesive stripe, for example by gluing, ultrasonic sealing, or heat sealing. The package is opened by detaching the different parts of the package from each other, for example by ripping. Thus, fibres attached to the adhesive stripe are not detached from the adhesive stripe but paper fibres are torn off the package material so that a thin layer of fibres remains attached to the adhesive stripe. The package is opened by utilizing this fibre rip.

In a conventional paper package, the mouth of the paper package is closed by an adhesive stripe between two paper walls, for example the front wall and rear wall of the package. The paper package is closed simply by spreading a layer of glue or other adhesive to the first paper wall, and by pressing the second paper wall onto it by means of first adhesive. The package can be opened by pulling the paper walls apart in a direction transverse to the adhesive stripe, whereby a fibre rip is formed at the adhesive stripe. A problem with a conventional paper package is that the fibre rip may extend past the adhesive stripe on the side of either the first or the second paper wall, whereby the wall of the package is weakened or may even be ripped open. The rip may extend a long way, even to the end of the wall, which may also cause an aesthetic impairment.

Another way to open a conventional paper package is to rip the package open at a location completely outside the adhesive stripe, in parallel with the adhesive stripe (for example, many typical tea bag envelopes). A problem with a package opened in this way is the shred which comes off the package and has to be separately disposed of. Moreover, the package may open up obliquely so that some of the contents of the package may leak from the package in an undesired way, or the contents of the package may be damaged.

Plastic packages do not involve the issue caused by a fibre rip. However, plastic packages are more problematic for the environment than paper packages, because they are normally made of oil-based starting materials and are not biodegradable.

Consequently, packages are needed which can be made of renewable and biodegradable materials, in which a fibre rip is prevented from extending outside the adhesive stripe, and which can be opened in a direction transverse to the adhesive stripe without parts coming off the package.

### BRIEF SUMMARY

The aspects of the disclosed embodiments are based on a paper package provided with a fibre rip stopper in connection with the seam closing the package. The paper package comprises at least a first package wall and a second package wall, as well as an adhesive stripe between the first wall and the second wall. The adhesive stripe forms the seam closing the package. The paper package further comprises at least one fibre rip stopper at the edge of the adhesive stripe or spaced from it in the direction of the interior of the package. The fibre rip stopper is configured to delimit the dividing line between the first wall and the second wall to the edge of the adhesive stripe or to a space from it in the direction of the interior of the package when the package is opened.

The stopper may also be arranged at a distance from the edge of the adhesive stripe towards the end point of the package wall. The end point may be a point where a fold is provided in said wall, or a point where the wall and the bottom of the package are joined.

The paper package according to the aspects of the disclosed embodiments has the advantage of being easy to open, compared with conventional paper packages sealed by gluing, ultrasonic sealing or heat sealing. The package is opened without the fibre rip extending down the wall of the package, so that the package is neatly opened at the desired location only. The package according to the aspects of the disclosed embodiments cannot be torn down the wall of the package since the fibre rip is stopped by the fibre rip stopper. Plastic bags and packages do not involve a fibre rip but, like a paper bag, they can be torn in an uncontrollable way.

Moreover, the paper package according to the aspects of the disclosed embodiments has the advantage that the package can be made of bio-based and biodegradable materials. The package is thus environmentally friendly and easy to be recycled or disposed of, for example by composting.

The paper package according to the aspects of the disclosed embodiments is also more pleasant for a user to use than conventional paper packages, from which a shred is torn off when opened. When the paper package according to the aspects of the disclosed embodiments is opened, no separate shred is torn off which should be separately disposed of, but the package remains in one piece.

The aspects of the disclosed embodiments thus relates to a paper package. The paper package comprises at least a first wall and a second wall, as well as an adhesive stripe between the first wall and the second wall. The adhesive stripe forms a seal closing the package at that side of the package where the package is arranged to be opened. The paper package further comprises at least one fibre rip stopper at the edge of the adhesive stripe or at a space (d) from it in the direction of the inner part of the package. The stopper is configured to limit the point separating the first wall and the second wall to the edge of the adhesive stripe or to a space (d) from it in the direction of the interior of the package when the package is opened.

In an embodiment, the paper package further comprises a third wall which is permanently attached to the second wall to form a seam closing the upper edge of the package, wherein the second wall constitutes a flap, under which the adhesive stripe is provided between the first wall and the second wall. In an embodiment, the paper package further comprises a third package wall which is permanently fastened to the first wall to form a seam closing the upper edge of the package, wherein the second wall constitutes a flap for the package, under which flap the adhesive stripe is provided to fasten the first wall and the second wall partly to each other so that the upper sections of the first wall and the second wall remain unattached. In an embodiment, the package is provided with two fibre rip stoppers so that the first fibre rip stopper is provided on the side of the adhesive stripe facing the first wall, and the second fibre rip stopper is provided on the side of the adhesive stripe facing the second wall. In an embodiment, the fibre rip stopper is arranged as a slit or an incision in at least the first wall or the second wall. In an embodiment, the fibre rip stopper is formed of a tab provided between the first wall and the adhesive stripe or between the second wall and the adhesive stripe so that the edge of the tab and the edge of the adhesive stripe are substantially overlapping, or the edge of the tab extends to a distance from the edge of the adhesive stripe, in the direction of the interior of the package. In an embodiment, the tab is formed of a slip of paper. In an embodiment, the tab consists of adhesive paper tape. In an embodiment, the tab consists of double-sided adhesive paper tape. In an embodiment, the paper package comprises two fibre rip stoppers, one in the first wall and the other in the second wall. In an embodiment, at least one of the two fibre rip stoppers is formed of a slip of paper or of double-sided adhesive paper tape.

The aspects of the disclosed embodiments also relate to a method for making a paper package. The manufacturing method comprises at least the following steps, whose order may vary:
providing a piece of paper or pieces of paper as the first wall and the second wall for the paper package,
fastening the first wall of the paper package and the second wall of the package to each other by means of adhesive, by ultrasonic sealing or by heat sealing,
providing an adhesive stripe between the first wall and the second wall of the package to form a seal closing the openable side of the paper package, and
providing a fibre rip stopper in connection with at least the first wall or the second wall of the package.

A method for making a paper package according to an embodiment, the method comprising: providing the fibre rip stopper in connection with the first wall or the second wall of the package before fastening the first wall and the second wall to each other and before providing the seal for closing the open-able side by means of an adhesive stripe. In an embodiment, the method for making a paper package further comprises gluing at least one tab of paper of fibre material onto the first wall or the second wall of the paper package, between the first wall and the second wall, wherein the openable side of the paper package is closed by material provided on the surface of the tab to form the adhesive stripe of the package, wherein the longitudinal edge of the tab facing the interior of the package constitutes the fibre rip stopper. In an embodiment, the method for making a paper package further comprises gluing at least one slip of paper or fibre material, i.e. a double-sided tape, which comprises compostable or recyclable pressure sensitive adhesive on its first planar surface and heat-sealable or ultrasonically sealable material on its second planar surface, with the adhesive on the first planar surface to the first wall or the second wall of the paper package, between the first wall and the second wall, wherein at least part of the heat-sealable or ultrasonically sealable material of the second planar surface constitutes the adhesive stripe of the package, and the longitudinal edge of the stripe which faces the interior of the package constitutes the fibre rip stopper. In an embodiment, the method for making a paper package further comprises gluing two tabs of paper or fibre material, the first one onto the first wall of the paper package and the second one onto the second wall of the paper package, wherein the adhesive stripe is formed between the tabs.

### DESCRIPTION OF THE DRAWINGS

In the following, the aspects of the disclosed embodiments will be described in more detail with reference to the appended drawings, in which

FIG. 1a shows a cross-sectional view of a package according to the aspects of the disclosed embodiments, wherein a fibre rip stopper is formed of a tab,

FIG. 1b shows a cross-sectional view of a package according to the aspects of the disclosed embodiments, wherein a fibre rip stopper is formed as a slit or an incision,

FIGS. 2a and 2b show cross-sectional views of a package according to the aspects of the disclosed embodiments, wherein two fibre rip stoppers are provided, each fibre rip stopper being formed of a tab,

FIGS. 3a and 3b show cross-sectional views of a package according to the aspects of the disclosed embodiments, the package comprising a flap structure and being provided with two fibre rip stoppers, wherein the first fibre rip stopper is formed of a tab, and the second fibre rip stopper is formed as a slit or an incision,

FIG. 4 shows a bag or a package, for example a bag for use as a package for food, particularly biscuits, cookies, crisps, chips, sweets, and other snacks, wherein the solution shown in FIGS. 2a and 2b is applied;

FIG. 5a shows a bag or a package, for example an envelope for use as a package for a tea bag, wherein the solution shown in FIGS. 3a and 3b is applied;

FIG. 5b shows a bag, for example an envelope for use as a package for a tea bag, wherein the solution shown in FIGS. 2a and 2b is applied;

FIG. 6 shows a cross-sectional view of a package, wherein a fibre rip stopper is arranged at a distance d from the edge of the adhesive stripe towards the interior of the package;

FIG. 7a shows a cross-sectional view of the package shown in FIGS. 2a and 2b, wherein a fibre rip stopper is formed by folding the edge section of the second wall of the package inwards;

FIG. 7b shows a cross-sectional view of the package shown in FIGS. 2a and 2b, wherein fibre rip stoppers are formed by folding the edge sections of the walls of the package inwards;

FIG. 7c shows a cross-sectional view of a package shown in FIGS. 3a and 3b, wherein the second wall and the third wall are formed of a single piece of paper by folding the piece of paper;

FIG. 7d shows a cross-sectional view of a package shown in FIGS. 3a and 3b, wherein the second wall, the third wall and a tab acting as a fibre rip stopper are formed of a single piece of paper by folding the piece of paper;

FIG. 8 shows a cross-sectional view of the package shown in FIGS. 2a and 2b, wherein fibre rip stoppers are formed by folding the edge sections of the walls of the package inwards and these folded sections outwards again, to provide a better grip for opening the package;

FIG. 9 shows a cross-sectional view of a package shown in FIGS. 2a and 2b, wherein the tabs acting as fibre rip stoppers extend outside the outer edges of the walls, to be used alone as gripping tabs for opening the package;

FIG. 10 shows a cross-sectional view of a package according to the aspects of the disclosed embodiments, wherein the package has a reverse flap structure wherein an adhesive stripe is provided between the first wall and the second wall of the package so that the adhesive stripe covers a slit or an incision provided in the first wall of the package;

FIG. 11 shows a front view of an embodiment of a bag or a package according to FIGS. 2a and 2b, wherein a hanging hole is provided in the section outside the adhesive stripe, for hanging the bag or package on a bar provided for this purpose in a store;

FIG. 12 shows a cross-sectional view of a bag or a package to be placed upright, in which a fibre rip stopper structure shown in FIGS. 2a and 2b or FIGS. 3a and 3b can be used, and which is suitable for use as a single envelope for a tea bag, from which the tea bag can be picked up and in which it can be put back after use;

FIG. 13 shows a cross-sectional view of a bag or a package according to the aspects of the disclosed embodiments, provided with a possible stopper structure;

FIG. 14 shows a bag or a package according to the aspects of the disclosed embodiments in a top view;

FIG. 15 illustrates the method of making a paper package according to the aspects of the disclosed embodiments in a flow chart;

FIG. 16a shows a cross-sectional view of a package according to the aspects of the disclosed embodiments, comprising a resealable closure

FIG. 16b shows a cross-sectional view of a package according to the aspects of the disclosed embodiments, comprising a resealable closure

FIG. 16c shows a cross-sectional view of a package according to the aspects of the disclosed embodiments, comprising a resealable closure; and

FIG. 16d shows a cross-sectional view of a package according to the aspects of the disclosed embodiments, comprising a resealable closure.

### DETAILED DESCRIPTION OF THE ASPECTS OF THE DISCLOSED EMBODIMENTS

In this application, the following reference numerals will be used:
1 first wall of package
2 second wall of package
3 fibre rip stopper
4 adhesive stripe
5 tab used as a fibre rip stopper
6 mouth of the package
7 fibre rip
8 slit acting as a fibre rip stopper
9 third wall of the package
10 hang hole
11 bottom of package
12, 13 support edges of package
14 handle
15, 15a, 15b resealable closure

In this application, a paper package refers to a package made of paper or combinations, i.e. laminates, of paper and other materials. The papers referred to in this application typically have a grammage lower than 250 g/m², lower than 180 g/m², or lower than 125 g/m², such as 20 to 250 g/m², 40 to 180 g/m², or 60 to 125 g/m². The paper referred to in this application is preferably compostable or biodegradable.

Even though the aspects of the disclosed embodiments is described with reference to a paper package which is normally based on wood-based or other fibres from plants, the package material may also comprise other fibres which, when intertwined, form the cohesive structure of the material, and have a susceptibility to rip off from the package material. In this context, the term paper thus covers any above mentioned package materials. The most advantageous raw materials for the package material are wood-based or pulp based fibres and other plant fibres as well as biodegradable synthetic fibres, in view of compostability and biodegradability of the package.

The paper package according to the aspects of the disclosed embodiments comprises at least a first wall 1 of the package and a second wall 2 of the package, as well as an adhesive stripe 4 between the first wall 1 and the second wall 2. The adhesive stripe 4 constitutes a seal closing the package. The paper package further comprises at least one fibre rip stopper 3 at the edge of the adhesive stripe 4. The fibre rip stopper 3 is provided to delimit the point separating the first wall 1 and the second wall 2 to the edge of the adhesive stripe 4 when the package is opened.

In this application, the wall refers to the wall delimiting the package, or a part of the wall. The wall may also refer to a flap-like section of the wall delimiting the package, arranged to partly overlap the second wall of the package.

In an embodiment, the paper package is made of a combination, i.e. a laminate, of paper and other materials. The laminate may comprise two or more material layers, of which one typically consists of paper. In an embodiment, the laminate comprises one layer of paper and another layer of a different material. In an embodiment, the laminate comprises three layers, of which one layer comprises paper and two other layers comprise other materials. The appropriate order of the layers in the laminate may be selected according to the use. Typically, paper constitutes the outermost layer in the laminate.

In some embodiments, one or more layers of the laminate may comprise fibre materials. As the fibre material, it is possible to use paper or other wood or pulp based fibre materials, such as wood fibre or non-woven materials. Preferably, the fibre material used in the laminate is biodegradable or compostable.

In some embodiments, one or more layers of the laminate may also comprise wood or pulp based materials other than fibre materials, such as film materials. In some embodiments, cellophane can be used as the film material.

In some embodiments, plastics can be used as layers in the laminate. The plastic used in the laminate may be selected from the group of polyethylene (PE), polypropylene (PP), polyethylene terephthalate (PET), bio-based and/or biodegradable plastics, such as polycaprolactone (PLC), polyvinyl alcohol (PVOH), polylactide (PLA), as well as combinations of these. Preferably, the paper-plastic laminate comprises paper and biodegradable plastic, which guarantees compostability of the package, particularly advantageously paper and polylactide (PLA).

In some embodiments, a biodegradable or compostable barrier material made by aqueous dispersion technology and not comprising plastics can be used as layers of the laminate. If this barrier layer is the innermost layer in the laminate (the layer left inside the package), it is preferably heat sealable or ultrasonically sealable.

In an embodiment, the paper package is made of a laminate comprising paper and heat sealable or ultrasonically sealable material. Preferably, the package is made of a heat sealable or ultrasonically sealable paper-plastic laminate or a laminate comprising paper and biodegradable or compostable barrier material made by aqueous dispersion technology and not comprising plastics. Particularly advantageously, the paper package is made of a heat sealable or ultrasonically sealable biodegradable paper-plastic laminate, such as a paper-polylactide (PLA) laminate. In another particularly advantageous embodiment, the heat sealable or ultrasonically sealable laminate comprises paper and biodegradable or compostable barrier material made by aqueous dispersion technology (so-called paper-barrier laminate).

In an embodiment, the paper package is made of a laminate which comprises paper in one layer, biodegradable plastic in a second layer, and cellophane in a third layer.

In some embodiments, the seams of the package may be formed by heat sealing. The adhesive stripe may also be formed by heat sealing.

In some embodiments, the seams of the package may be formed by ultrasonic sealing or in the form of an ultrasonic seam. The adhesive stripe may also be formed as an ultrasonic seam.

In an embodiment, the adhesive stripe is formed in the form of an adhesive seam. As the adhesive, it is possible to use any adhesive suitable for manufacturing and sealing of paper packages, such as hot melt adhesive, preferably biodegradable adhesive, such as biodegradable hot melt adhesive.

Even if the fibres of the fibre material of the package comprising the laminate are not in direct contact with the adhesive, a fibre rip may be formed in a package made of the laminate as well. If the package material is a laminate in which one or more layers are provided between the fibre material layer and the adhesive stripe in the finished package, the fibre material layer will be susceptible to a fibre rip when said one or more layers adhere to the adhesive stripe as the package is ripped open, and simultaneously pull off fibres from the fibre material layer.

The first wall 1 and the second wall 2 of the package may be attached to each other at the sides of the package by means of adhesive, such as glue, by ultrasonic sealing or heat sealing, or by another suitable method. FIGS. 5a and 5b show a package where the first wall and the second wall are attached to each other at the sides of the package.

In an embodiment, the first wall 1 and the second wall 2 of the package, for example the front wall and the rear wall of the package, may be formed of a single continuous piece of paper.

The first wall 1 and the second wall 2 may each be separately formed of one or more pieces of paper. The front wall of the paper package may be formed of a single continuous piece of paper, or two or more pieces of paper attached to each other. The rear wall of the package may be formed of a single continuous piece of paper, or two or more pieces of paper attached to each other. The front wall or the rear wall of the package may comprise a vertical seam or several vertical seams.

Preferably, the package is arranged to be sealed in an air-tight manner, whereby it is particularly suitable for packing food. The package is opened by detaching the first wall 1 and the second wall 2 from each other at the adhesive stripe 4. The how tight the adhesive stripe 4 is attached to a wall depends, for example, in a case of heat sealing, the amount of the heat sealable material in a wall or walls. For example, if the first wall comprises more heat sealable material that the second wall, the adhesive stripe 4 is more tightly attached to the first wall than to the second wall, and it is more likely that the second wall at least tears away from the adhesive stripe 4, and a fibre rip occurs in that second wall i.e. paper fibres of the second wall are torn off the second wall so that a thin layer of fibres remains attached to the adhesive stripe 4. In this kind of situation, a fibre rip stopper 3 is at least needed in that second wall.

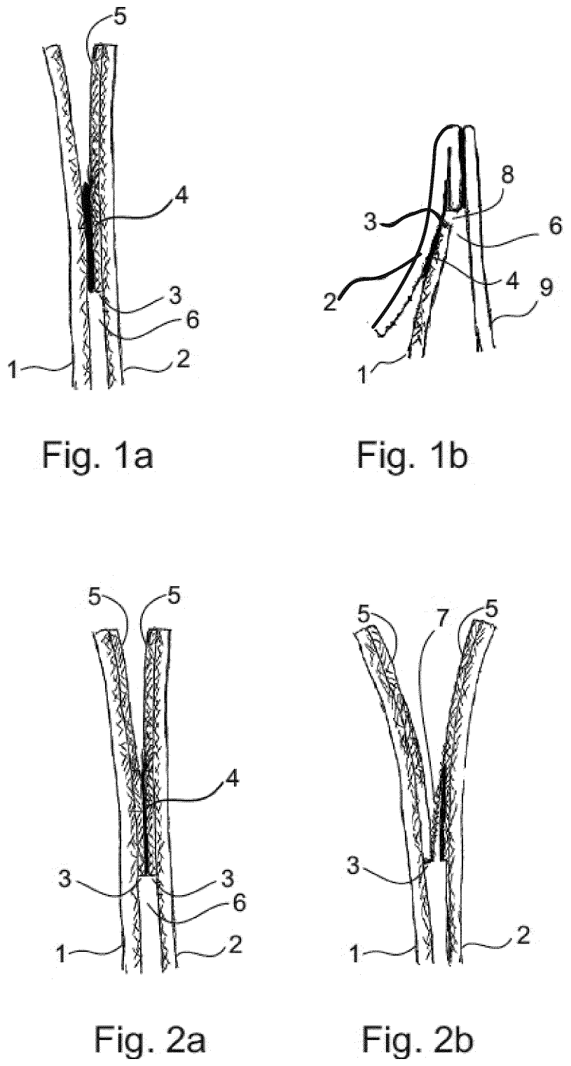

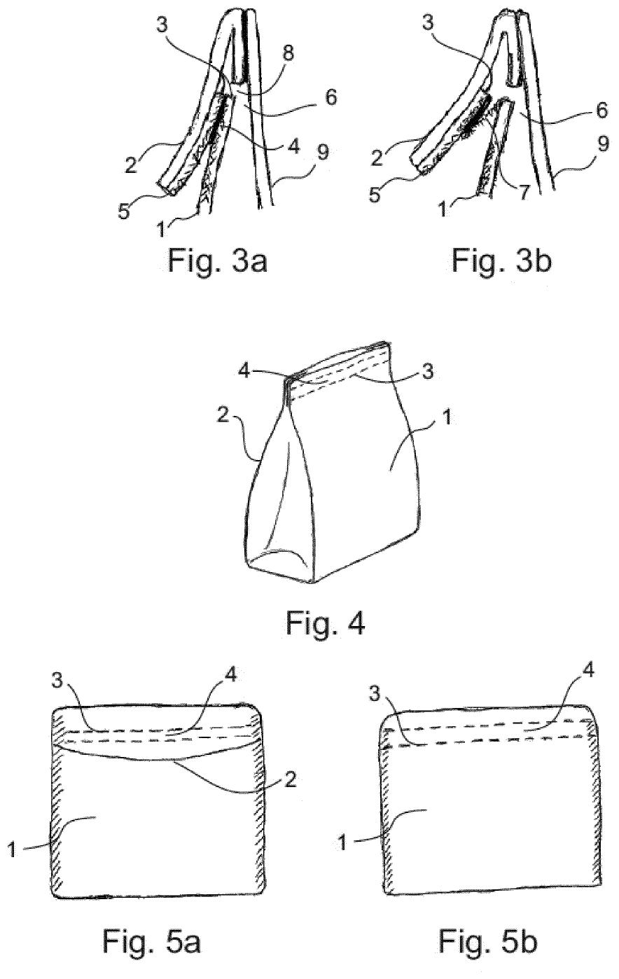

The detaching of the first wall 1 and the second wall 2 from each other is facilitated by the fact that extending from the adhesive stripe 4 outwards (when seen from the direction of the package), the first wall 1 and the second wall 2 are detached from each other, forming gripping flaps. By gripping the gripping flaps from the outside of the package, it is easy to rip the walls 1, 2 off each other. In FIGS. 1a and 2a, the free upper edge parts of the walls 1, 2 constitute the gripping flaps apart from each other, and in FIG. 3a, the gripping flap is formed by the free edge part of the second wall 2.

In an embodiment, the package is provided with two fibre rip stoppers 3. FIGS, 2a, 2b, 3a, and 3b show cross-sectional views of packages according to this embodiment. A first fibre rip stopper 3 is provided in the adhesive stripe 4 on the side facing the first wall 1, and a second fibre rip stopper is provided in the adhesive stripe 4 on the side facing the second wall 2. This embodiment has the advantage that the fibre rip cannot extend on either side of the adhesive stripe 4. The package will always open so that the fibre rip does not extend across the mouth 6 of the package or beyond the edge of the adhesive stripe 4. Consequently, the wall of the package cannot be damaged when the package is opened. The contents of the package will remain fine when the package is opened.

In an embodiment, the fibre rip stopper 3 is arranged as a slit or an incision 8 in at least the first wall 1 or the second wall 2. Packages according to this embodiment are shown in FIGS. 1b, 3a, 3b, 5a, and 10. The figures show a flap which is lifted for opening the package. The flap is formed of the second wall 2. Thanks to the slit 8, a fibre rip will be automatically stopped, whereby the package is easy to open, and the wall of the package is not damaged by the fibre rip extending further.

In an embodiment, the fibre rip stopper 3 is formed of a tab 5, such as a slip of paper or adhesive paper tape, which is provided between the first wall 1 and the adhesive stripe 4 or between the second wall 2 and the adhesive stripe 4 so that the edge of the tab 5 and the edge of the adhesive stripe 4 are substantially on top of each other. Packages according to this embodiment are shown in FIGS. 1a, 2a and 2b, 3a, 3b, 4 to 10, and 12. The package can be opened either by ripping at the top of the package (FIGS. 2a, 2b, 4, 5b, and 6, 7a, 7b, and 8 to 10) or by lifting the flap (FIGS. 3A, 3b, 5a, 7c, 7d, and 12). The edge of the tab 5 acts as the fibre rip stopper 3 when the tab 5 and the adhesive stripe 4 are arranged so that their edges are substantially on top of each other, that is, they extend along the same line in parallel with the upper edge of the package, or when the fibre rip stopper 3 is spaced by a distance d from the adhesive 4 stripe in the direction of the inner part of the package.

Like the walls, the tab 5 may thus consist of paper, i.e. a slip of paper or consist of adhesive paper tape i.e. a slip of adhesive paper tape. It may consist of the same material as the walls of the package, or of a different material. In other words, instead of paper, the tab 5 may be made of a compostable fibre material, i.e. it may be a slip of compostable fibre material, or it may be made of a laminate comprising paper, i.e. be a slip of laminate comprising paper. Because the adhesive stripe 4 is attached to this tab 5, fibres from the tab 5 may adhere to it when the package is opened, but thanks to the fibre rip stopper 3, this fibre rip caused by gripping cannot extend beyond the fibre rip stopper 3.

A tab 5 made of paper or another compostable fibre material may thus also be a piece, strip or slip of adhesive paper tape which comprises compostable or recyclable pressure sensitive adhesive on its first planar surface and heat sealable or ultrasonically sealable material on its opposite i.e. second side. It may also be possible to use heat sensitive adhesive instead of pressure sensitive adhesive on the first planar surface. The heat sensitive adhesive will adhere to the package material at a temperature substantially lower than the temperature at which heat sealable material possibly provided on the first surface is sealed. The heat sensitive adhesive may also consist of compostable or recyclable material. In an embodiment, the heat sealable or ultrasonically sealable material comprises paper and biodegradable or compostable barrier material made by aqueous dispersion technology and not comprising plastics. In this context, such an alternative tab 5 made of paper or fibre material, comprising pressure sensitive or heat sensitive adhesive on its first planar surface and heat sealable or ultrasonically sealable material on its second surface, is called double-sided adhesive paper tape. The heat sealable or ultrasonically sealable material of the double-sided adhesive paper tape, or at least part of it, constitutes the adhesive stripe 4 which forms the seam closing the package at that side of the package where the package is arranged to be opened. In other words, an alternative paper package comprises at least one length, i.e. a piece, of double-sided adhesive paper tape, i.e. a tab 5 made of paper or fibre material, which acts both as a fibre rip stopper 3 and as an adhesive stripe 4, and it is fastened to that side of the package where the package is arranged to be opened. On its first planar surface, compostable or recyclable pressure sensitive or heat sensitive adhesive is provided, by means of which double-sided adhesive paper tape is glued, by applying pressure, onto either the first wall 2 or the second wall 2 in the interspace between the first wall 1 and the second wall 2, at the edge of the package to be opened. On the second planar surface of the double-sided adhesive paper tape, heat sealable or ultrasonically sealable material is provided, and at least part of the heat sealable or ultrasonically sealable material constitutes an adhesive stripe 4 by which the first wall 1 and the second wall 2 are attached together to form the seam closing the package and arranged to be opened. The edge of the tape, i.e. the tab 5, facing the interior of the paper bag, constitutes the fibre rip stopper 3.

In the double-sided adhesive paper tape, one side i.e. planar surface is thus the surface comprising pressure sensitive or heat sensitive adhesive or glue, and it is fastened to the package itself. The other side i.e. planar surface of the tape is thus the surface comprising heat sealable or ultrasonically sealable material, by means of which the package is closed after filling i.e. packing the contents of the package, either by heat sealing or ultrasonically. The pressure sensitive adhesive has such a strength of adhesion to the wall of the package that it will remain attached to the wall of the package onto which it has been glued, when the package is opened. The heat sealable or ultrasonically sealable seam is arranged such that the seam can be opened by applying moderate but sufficient force. Thus, the heat sealable or ultrasonically sealable seam is arranged to unfasten, i.e. the package is opened, more easily than the adhesive, by which the tape is attached to the wall of the package, is detached from the wall.

Nevertheless, it is also possible that in some applications, both sides i.e. planar surfaces of the adhesive paper tape comprise pressure sensitive adhesive. In this case, different surfaces of the adhesive paper tape may comprise adhesive in different adhesive strengths. For example, the side i.e. surface of the tape to be attached to the package may have a higher adhesive strength than that side of the tape by which the package is closed after filling i.e. packing the contents of the package, in other words that side of the tape which forms the sealable seam at which the package is intended to be opened.

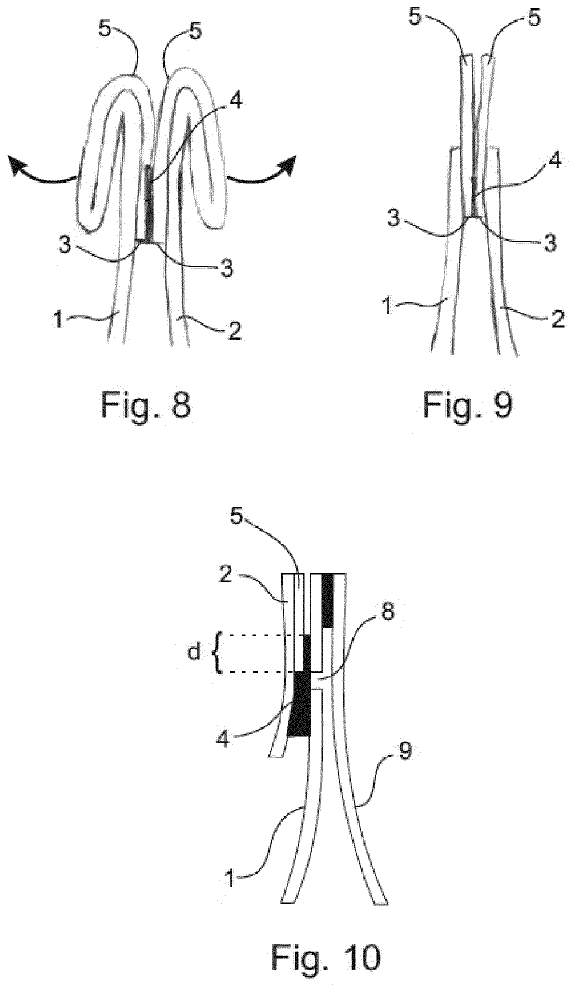

In an embodiment, the package comprises a first wall 1 and a tab 5 formed of the same continuous piece of paper as the first wall 1, as well as a second wall 2 and tab 5 formed of the same continuous piece of paper as the second wall 2. FIGS. 7b and 8 show cross-sectional views of a package according to this embodiment.

The paper package may also comprise a third wall 9 so that the third wall 9 is permanently fastened to the first wall 1 or the second wall 2 to form the seam sealing the upper edge of the package. This structure is shown in FIGS. 1b, 3a, 3b, and 10. The seam closing the upper edge of the package may be formed, for example, by gluing, heat sealing, ultrasonic sealing, stapling, or another suitable method. Thus, the second wall 2 constitutes a flap, under which an adhesive stripe 4 is attached between the first wall 1 and the second wall 2 so that a fibre rip stopper 3 is provided at the edge of the adhesive stripe 4 or at a distance d from the edge of the adhesive stripe 4 in the direction of the interior of the package. In an embodiment, two fibre rip stoppers 3 are provided at the edge of the adhesive stripe 4 so that the first fibre rip stopper 3 is provided on the side of the adhesive stripe 4 facing the first wall 1, and the second fibre rip stopper 3 is provided on the side of the adhesive stripe 4 facing the second wall 2. Preferably, the first fibre rip stopper 3 is formed of a tab 5, such as a slip of paper, provided between the second wall 2 and the adhesive stripe 4, and the second fibre rip stopper 3 is formed as a slit or an incision 8 in the first wall 1. This embodiment has the advantage that the fibre rip cannot extend further on either side of the adhesive stripe 4. On the side of the flap and on the side of the second slip of paper, the fibre rip will stop at the edge of the tab 5 and at the slit 8, respectively. Thus, the package is always opened in such a way that the fibre rip will not extend across the mouth 6 of the package or beyond the edge of the adhesive stripe 4.

The second wall 2 and the third wall 9 of the package may be formed of a single continuous piece of paper, for example by folding the piece of paper. FIGS. 7c, 7d and 12 show cross-sectional views of packages according to this embodiment.

The first wall 1, the second wall 2 and the third wall 9 of the package may be formed of a single continuous piece of paper, for example by folding the piece of paper. FIG. 12 shows a cross-sectional view of a package according to this embodiment.

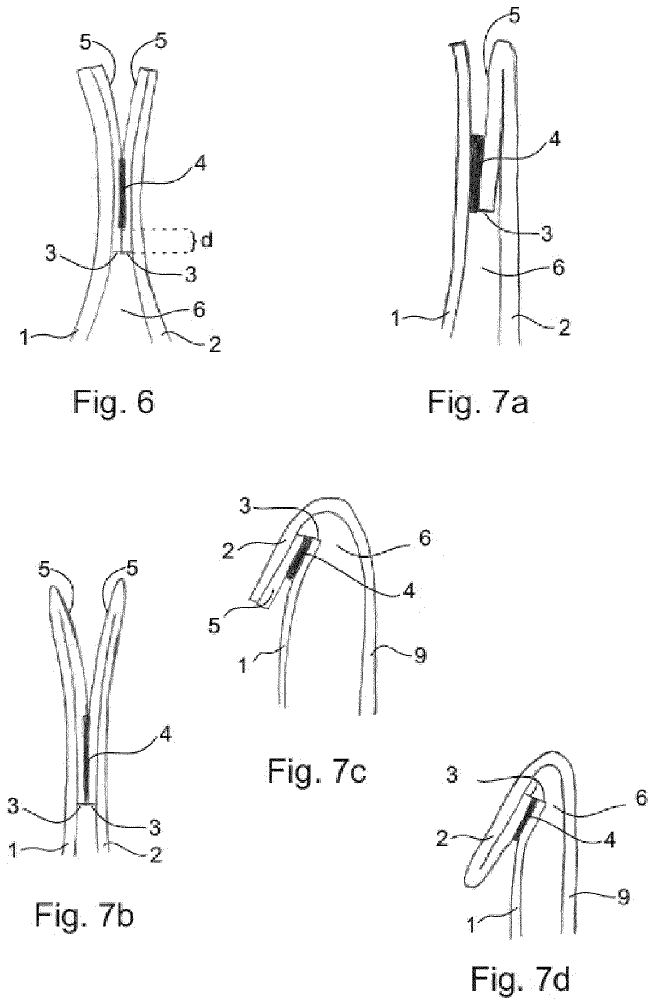

The adhesive stripe 4 and the fibre rip stopper 3 are not necessarily on the same level. The fibre rip stopper 3 may be spaced by a distance d from the edge of the adhesive stripe 4 in the direction of the interior of the bag or package. Packages according to this embodiment are shown in a cross-sectional view in FIG. 6. Even if the fibre rip extended beyond the edge of the adhesive stripe 4, it will still stop at the edge of the tab 5 extending slightly further in the direction of the interior. For saving material and utilizing the effects of the aspects of the disclosed embodiments, however, it is preferable that the tab 5 does not extend very far along the wall. A possible distance d is preferably not greater than the width of the adhesive stripe 4, preferably not greater than half of it, most preferably only a quarter of it. This distance d can naturally be applied to the embodiments shown in the other figures as well.

In an embodiment, the tab 5 may be formed of the same piece of paper as the first wall 1 or the second wall 2 of the package, for example by folding the edges of the pieces of paper inwards, whereby the edges of the folded sections constitute the fibre rip stoppers 3. In an embodiment, the tab 5 may be formed of the same piece of paper as the first wall 1 of the package. Correspondingly, the tab 5 may be formed of the same piece of paper as the second wall 2 of the package. FIGS. 7a, 7b, 7d, and 8 show cross-sectional views of packages according to this embodiment. The folded sections can be fastened to the inner edges of the walls 1, 2 by adhesive, for example by gluing, ultrasonic sealing, or heat sealing. However, this is not necessary, because the adhesive stripe 4 constitutes a seam sealing the package tightly.

The second wall 2, the third wall 9, and the tab 5 of the package may be formed of the same piece of paper, for example by folding the piece of paper. FIG. 7d shows a cross-sectional view of a package according to this embodiment.

The first wall 1, the second wall 2, the third wall 9, and the tab 5 of the package may be formed of a single continuous piece of paper, for example by folding the piece of paper.

FIG. 8 shows an embodiment which is a further development of the embodiment of FIG. 7b. The folds of the doubled first and second walls 1, 2 are folded a second time outwards to extend approximately in parallel with the walls 1, 2. These folds can be spread out as shown by the arrows, whereby they act as gripping flaps and make it easier to open the package for persons having weak finger force.

FIG. 9 shows a cross-sectional view of an alternative embodiment to the embodiment shown in FIGS. 2a and 2b. The outer edges of the tabs 5 do not necessarily need to be on the same level as the outer edges of the first wall 1 and the second wall 2. The tabs 5 are fastened to the inner faces of the walls 1 and 2 so that they extend a given width beyond the outer edges of the walls 1 and 2. In this way, they can be used directly as gripping flaps for opening the package.

A requirement for unproblematic opening of the package or bag is that the tabs 5 are detached from each other outside the adhesive stripe 4 so that they can gripped from the outside of the package or bag, and it can be secured that the package will rip open neatly at the adhesive stripe 4.

FIG. 10 shows a cross-sectional view of a package having a so-called inverse flap structure with respect to the flap shown in FIGS. 1b, 3a and 3b, openable from below. The first wall 1 and the third wall 9 of the package are permanently attached to each other at the top of the package. The first wall 1 of the package is provided with a slit or an incision 8 which acts as the first fibre rip stopper 3. The second wall 2 of the package constitutes a flap, under which the adhesive stripe 4 attaches the first wall 1 and the second wall 2 of the package together. In this embodiment, the adhesive stripe 4 covers the slit 8 so that the upper edge of the slit 8 is spaced by a distance d from the upper edge of the adhesive stripe 4 in the direction of the interior of the package. A tab 5 is provided inside the second wall 2 of the package, acting as the second fibre rip stopper 3. The upper part of the first wall 1 and the upper part of the second wall 2 are not attached to each other, whereby these free edge parts constitute gripping flaps which can be gripped to easily rip open the package. The package according to this embodiment can be filled by first forming the slit 8 in the first wall 1, after which the first wall 1 and the second wall 2 are attached to each other by the adhesive stripe covering the slit 8. At the filling stage, the product to be contained in the package can be filled between the first wall 1 and the third wall 9 before these are fastened together. Finally, at the stage of closing the package, the first wall 1 and the third wall 9 can be fastened or seamed together.

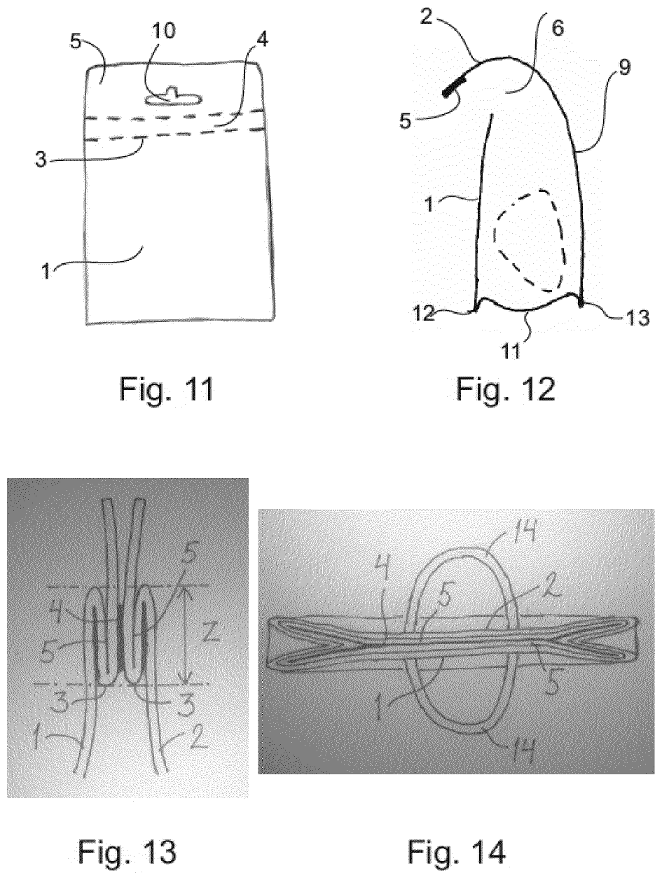

FIG. 11 shows a bag-like package with a hang hole 10 for hanging on a bar, for example, in a store. The hang hole 10 is above the adhesive stripe 4, in the area of the free edge sections (package shown in FIGS. 2a and 2b) or in the area of the upper part of the flap where the first wall and the third wall are permanently fastened together (package shown in FIGS. 3a and 3b). If the side edges of the package are formed by folds (bag with a vertical rear seam), they are not torn so easily when the package is opened from above by ripping the tabs 5 apart. The bag shown in the figure is particularly suitable for packing sweets or snacks.

FIG. 12 shows a single package for a tea bag, in which the structure according to the aspects of the disclosed embodiments can be applied. The package is of the type presented in the applicant's earlier international patent application WO 2011/131832. It has the structure shown in FIGS. 3a and 3b, that is, a first wall 1 forming the front wall and a third wall 9 forming the rear wall, each extending down to their respective supporting edge 12, 13. The supporting edges can be moved away from each other, thereby spreading the bottom 11 of the package to form a supporting structure keeping the package upright. The FIG. 12 shows the package in its spread out state. In the flattened state, the bottom consists of a folded part extending upwards within the package, allowing the bottom to expand, and being formed by providing the lower part of the front wall and the rear wall with folds forming said supporting edges 12, 13. The front wall and the rear wall are seamed together at the side edges; that is, the opposite inner faces of the package material are attached to each other in a zone having a given width. Also, both supporting edges 12, 13 are preferably provided with seams where the inner faces of the package material are attached together in a zone having a given width on both sides of the folding line, which makes the supporting structure of the bottom more sturdy and more stable in its spread out state, as shown in the figure.

The mouth 6 of the package is formed between the second wall 2 (flap) and the first wall 1 (front wall) as shown in FIGS. 3a, 3b, but it may also be formed between the first and second walls 1, 2, as shown in FIG. 2a, 2b, 6, 7b, 8, or 8. In FIG. 12, the walls 1, 2 and 9 (including the bottom 11) are formed of the same piece of paper, but the second wall 2 may also be attached as a separate piece to the third wall 9, as shown in FIGS. 3a and 3b.

FIG. 13 shows how the fibre rip stoppers 3 are not necessarily formed by the cut edges of the tabs 5. The folding line of the double tab 5 may form an edge acting as a stopper 3 in the same way, because it constitutes a discontinuity in the wall of the package. In FIG. 13, this is implemented so that the tab is formed of the same piece of material as the wall of the package. At its upper part, the wall is threefold at a space from the upper edge in a zone z having a given width, so that a twofold tab 5 is formed inside the wall. At said zone z, the tab 5 is fastened by the adhesive stripe 4 to another tab 5 similarly formed in the opposite wall. The free upper edges of the tabs 5 above the adhesive stripe 4 are apart from each other and constitute gripping flaps for opening the package. The twofold tab 5 is permanently attached to the wall of the package by, for example, gluing, whereby the folding point constitutes a “step” acting as the stopper 3 on the wall of the package in the same way as the edges of the tabs 5 in the other embodiments. If the material for the paper package comprises heat sealable or ultrasonically sealable material on its inner face, the tabs 5 formed by folding can be attached to the walls of the package and to each other by heat sealing or ultrasonic sealing at the zone z.

FIG. 14 shows yet another embodiment applied to paper bags in which the side edges are folded in, seen from above. The tab 5 encircles the whole mouth of the bag on its inside, and it may be formed in any of the ways described above. Because the tab 5 reinforces the upper part of the bag, it can be equipped with handholds 14, whereby the bag can used as a carrier bag. The bag is suitable for packing, for example, takeaway products, whereby it can be tightly closed at the point of sale by, for example, heat sealing or ultrasonic sealing, and the buyer can easily open the package after transportation. The handholds 14 can also be used for hanging, if the bag is used for retail selling of pre-packed products in stores.

Thanks to all the above mentioned embodiments, the package can be opened to the whole width of the first wall 1 and the second wall 2 by a single movement transverse to the direction of the adhesive stripe 4, without having to expand the mouth by ripping the material, for example, along a perforation or another weakening line. In this way, a full-width mouth, preferably extending from one edge to another edge of the wall, is quickly obtained.

The package according to the aspects of the disclosed embodiments can be made by a method comprising at least the following steps:
providing a piece of paper forming the first wall 1 of the package, and a piece of paper forming the second wall 2 of the package; the piece of paper may also be a single continuous piece of paper which is folded to form two pieces of paper: the first one for the first wall 1 and the second one for the second wall 2;
fastening the first wall 1 and the second wall 2 of the package to each other, for example at the sides or the rear seam of the package, for example in the case of a single continuous piece of paper, which fastening is done by using an adhesive, such as glue, by ultrasonic sealing or by heat sealing;
providing at least the first wall 1 or the second wall 2 of the package with at least one fibre rip stopper 3, which stopper 3 may thus be a slit or an incision made in the first wall 1 and/or the second wall 2 of the package, the edge of a tab 5 provided in the first wall 1 and/or the second wall 2 e.g. by gluing, or a slit or an incision made in the glued tab 5; in addition or alternatively, the stopper 3 may also be the edge of a folded wall, such as the edge of the second wall 2 shown in FIG. 1b, or only the edge of the wall, such as the edge of the first wall 1 in FIG. 3a; and
providing an adhesive stripe 4 between the first wall 1 and the second wall 2 of the package to form a seam closing the package, wherein the fibre rip stopper 3 is configured to restrict the point of separation of the first wall 1 and the second wall 2 to the edge of the adhesive stripe 4 or to a distance d from it in the direction of the interior of the package, when the package is opened.

In the above-mentioned method, it is also possible to use another suitable material, such as fibre material, instead of paper, i.e. pieces of paper.

In the method, double-sided adhesive paper tape may be used as the tab 5 instead of a slip of paper or a slip of laminate, wherein the longitudinal edge of the tab 5, such as the adhesive paper tape, constitutes the fibre rip stopper 3, and one surface of the adhesive paper tape, the heat sealable or ultrasonically sealable material, is provided with an adhesive stripe 4, forming the seam between the first wall 1 and the second wall 2 closing the package upon sealing.

The method can be applied in a packaging machine, for example, by introducing double-sided tapes to the package material which is unrolled as a continuous web from a roll to the machine. The tapes are introduced from their own rolls into the packaging machine so that they are attached by their adhesive onto the packaging material web, at its both edges, in such a position that they constitute the above mentioned tabs in the finished packages. As the tapes, it is possible to use, for example, such double-sided tapes whose surfaces containing adhesive are attached onto the unrolled packaging material, and whose visible surfaces on the packaging material web consist of heat sealable or ultrasonically sealable material.

The package can be made by using machines, equipment, and methods already typically used in the industry.

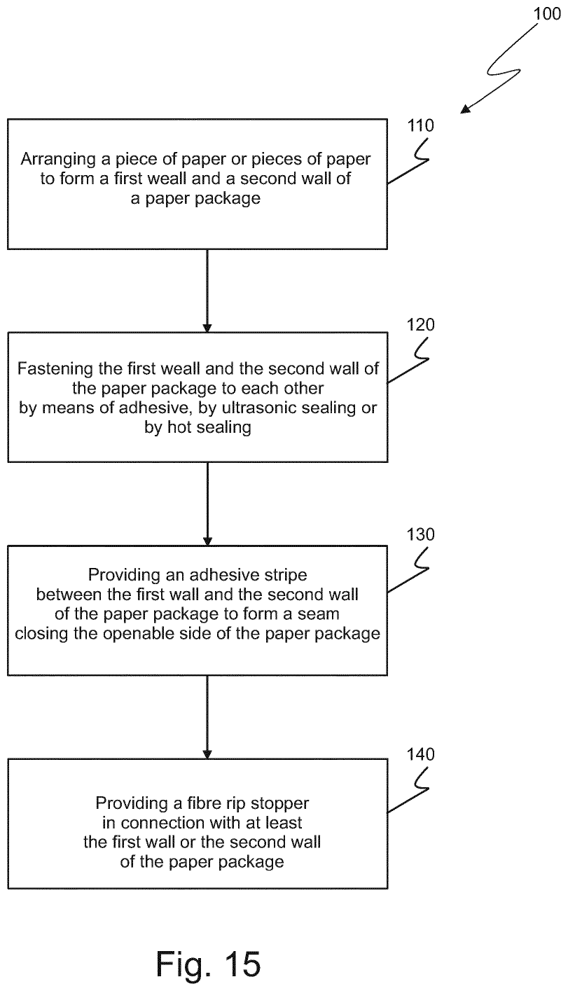

FIG. 15 shows a flow chart of a method 100 for manufacturing a paper package according to the aspects of the disclosed embodiments. The method 100 comprises at least the following steps, whose sequence may vary. A method step 110 comprises arranging a piece of paper or pieces of paper to form a first wall and a second wall of a paper package. A method step 120 comprises fastening the first wall and the second wall of the paper package to each other by means of adhesive, by ultrasonic sealing or by heat sealing. A method step 130 comprises providing an adhesive stripe between the first wall and the second wall, to form a seam closing the openable side of the paper package.

A method step 140 comprises providing a fibre rip stopper in connection with at least the first wall or the second wall of the package.

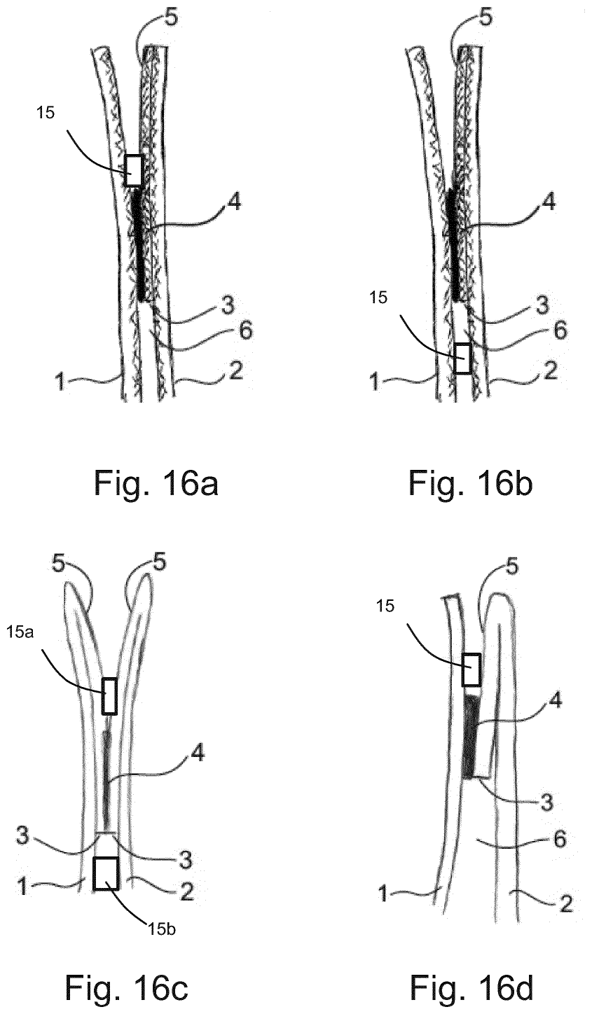

FIG. 16a shows a cross-sectional view of a package according to the aspects of the disclosed embodiments, comprising a resealable closure 15. The package corresponds the structure of package shown in FIG. 1a, but it has that resealable closure 15 above the adhesive stripe 4 forming a seam closing the package. In other words the resealable closure 15 is, in this example embodiment, on that side of the adhesive stripe 4 where the package is arranged to be opened.

FIG. 16b shows a cross-sectional view of a package according to the aspects of the disclosed embodiments, comprising a resealable closure 15. The package corresponds the structure of package shown in FIG. 16a, but its resealable closure 15 is under the adhesive stripe 4 when seen from the direction where the package is arranged to be opened.

FIG. 16c shows a cross-sectional view of a package according to the aspects of the disclosed embodiments, comprising two alternative places for a resealable closure 15a, 15b. The package corresponds the structure of package shown in FIG. 7b, but it has in a first option the resealable closure 15a above the adhesive stripe 4 i.e. the resealable closure 15a is on that side of the adhesive stripe 4 where the package is arranged to be opened. In a second option the resealable closure 15b is arranged under the adhesive stripe 4 when seen from the direction where the package is arranged to be opened.

FIG. 16d shows a cross-sectional view of a package according to the aspects of the disclosed embodiments, comprising a resealable closure 15.

The package corresponds the structure of package shown in FIG. 7a, but it has the resealable closure 15 above the adhesive stripe 4 forming a seam closing the package in other words the resealable closure 15 is on that side of the adhesive stripe 4 where the package is arranged to be opened.

The resealable closure 15, 15a, 15b may be any suitable resealable structure that is resealable by pressing so that the package closes. The resealable closure 15, 15a, 15b may be, for example a resealable tape strip or seal or an adhesive line or lines attached to the first wall 1 or the second wall 2 of the package, and between the first wall 1 and the second wall 2, or a zip structure i.e. zip lock or corresponding and comprising its counterparts in the first wall 1 and the second wall 2, between the first wall 1 and the second wall 2. The resealable tape strip or seal or adhesive line may be covered by a piece of paper or corresponding, before the resealable closure is taken into use to avoid accidental adhesion. It should be noted that a resealable closure is also suitable to be used in other package shapes according to the aspects of the disclosed embodiments, for example, in packages shown in FIGS. 1b (in its flap), 2a, 3a, 6, 7c, 8, 9, 10, and 13. It is also possible that one package comprises more than one resealable closure, for example one above and one under an adhesive stripe 4 for ensuring more efficient resealing.

The package can be made, for example, by using a tube along which the product to be filled in the package is dropped into the bag. Thus, the first wall 1 and the second wall 2 of the package are formed of a single continuous piece of paper which is seamed together at the rear wall of the bag (so-called back seam bag), around the tube for filling products. The piece of paper is wrapped around the tube, and the seam closing the package is formed after the filling of the products, and single packages are cut out. In this case, the piece of paper may be provided with stripes at desired spacing from each other in advance. In the seaming step, each stripe is pressed against itself when the piece of paper is folded, whereby the lower and upper seams of the package are formed. The stripes are left between the upper seam of the package, whereby they act as stoppers for fibre rip.

The package can be made of a wide piece of paper, so-called film, with several bag blanks in parallel. The product and marketing imprints to be provided on the packages may be printed on the film all at once before single packages are formed of the film. The tab used as a fibre rip stopper can be attached to the film before the film is cut into smaller bag blanks and rolled, shaped, seamed, and cut into single bags. The tab can be unrolled and seamed onto the film by means of a roll and heat (heat sealing) or ultrasound (ultrasonic sealing). The film is cut into bag blanks at the location of the tabs.

Alternatively, the tab used as a fibre rip stopper can be formed after cutting of the film, by folding the edge of the bag blank. The paper cut out of the bag blank can be folded in the middle, whereby the tabs for stopping a fibre rip, attached to the edges of the blank, can be seamed together, as well as the sides of the package.

In addition, it may be profitable to use double paper layers in an area of an adhesive stripe 4. The double paper layers may be formed when the top of the paper is folded down into a kind of flap. See e.g. FIG. 7b. Due to folded paper, it is possible to use thinner paper quality. It is however also possible to use double paper layers in context with other packages according to the aspects of the disclosed embodiments, for example, the first wall of the package shown in FIGS. 7c and 7d may benefit of double paper layer.

The features of the aspects of the disclosed embodiments described and the embodiments mentioned in the application are freely combinable and interchangeable, except if the application particularly states that the embodiments or features are not interchangeable. The exemplary features described in connection with the different embodiments can be used with any other embodiment even if this were not mentioned separately.

1. A paper package comprising at least a first wall and a second wall, as well as an adhesive stripe between the first wall and the second wall, the adhesive stripe forming a seam closing the package on that side of the package where the package is arranged to be opened, which package is configured to be opened by pulling the first wall and the second wall apart in a direction transverse to the adhesive stripe, wherein the adhesive stripe further constituting a seal configured to seal the package is formed by heat sealing, ultrasonic sealing or hot melt adhesive, the paper package also comprises at least one fibre rip stopper at the edge of the adhesive stripe or at a distance from it in the direction of the interior of the package, the fibre rip stopper being configured to delimit the point separating the first wall and the second wall.

2. The paper package according to claim 1, wherein the paper package further comprises a third wall which is permanently attached to the second wall to form a seam closing the upper edge of the package, wherein the second wall constitutes a flap, under which the adhesive stripe is arranged between the first wall and the second wall.

3. The paper package according to claim 1, wherein the paper package further comprises a third package wall which is permanently fastened to the first wall to form a seam closing the upper edge of the package, wherein the second wall constitutes a flap for the package, under which flap the adhesive stripe is arranged to fasten the first wall and the second wall partly to each other so that the upper parts of the first wall and the second wall remain unattached.

4. The paper package according to claim 1, wherein the package is provided with two fibre rip stoppers so that the first fibre rip stopper is provided on the side of the adhesive stripe facing the first wall, and the second fibre rip stopper is provided on the side of the adhesive stripe facing the second wall.

5. The paper package according to claim 1s, wherein the fibre rip stopper is arranged as a slit or an incision in at least the first wall or the second wall.

6. The paper package according to claim 1, wherein the fibre rip stopper is formed of a tab provided between the first wall and the adhesive stripe or between the second wall and the adhesive stripe so that the edge of the tab and the edge of the adhesive stripe are substantially overlapping, or the edge of the tab extends to a distance from the edge of the adhesive stripe, in the direction of the interior of the package.

7. The paper package according to claim 6, wherein the tab is formed of a slip of paper.

8. The paper package according to claim 6, wherein the tab consists of double-sided adhesive paper tape.

9. The paper package according to claim 1, comprising two fibre rip stoppers, one in the first wall and the other in the second wall.

10. The paper package according to claim 9, wherein at least one of the two fibre rip stoppers is formed of a slip of paper.

11. The paper package according to claim 9, wherein at least one of the two fibre rip stoppers is formed of double-sided adhesive paper tape.

12. The paper package according to claim 1, comprising a resealable closure.

13. A method for making a paper package, the method comprising at least the following steps:
providing at least one piece of paper as the first wall and the second wall for the paper package,
fastening the first wall of the paper package and the second wall of the package to each other by means of an adhesive, by ultrasonic sealing or heat sealing,
providing an adhesive stripe by heat sealing, ultrasonic sealing or hot melt adhesive between the first wall and the second wall of the package to form a seam closing the openable side of the paper package and a seal sealing the paper package, and
providing a fibre rip stopper in connection with at least the first wall or the second wall of the package configured to be opened by pulling the first wall and the second wall apart in a direction transverse to the adhesive stripe.

14. The method for making a paper package according to claim 13, wherein the method comprises providing the fibre rip stopper in connection with the first wall or the second wall of the package before the first wall and the second wall are fastened to each other and before the seam for closing the openable side is provided by means of the adhesive stripe.

15. The method for making a paper package according to claim 13, wherein the method further comprises:
arranging at least one tab made of paper of fibre material onto the first wall or the second wall of the paper package by means of the adhesive, between the first wall and the second wall, wherein the openable side of the paper package is closed by material provided on the surface of the tab to form the adhesive stripe of the package, and wherein the longitudinal edge of the tab facing the interior of the package constitutes the fibre rip stopper.

16. The method for making a paper package according to claim 13, wherein the method further comprises:
arranging at least one tab made of paper or fibre material and comprising compostable or recyclable pressure sensitive adhesive on its first planar surface and heat-sealable or ultrasonically sealable material on its second planar surface, by means of the adhesive on the first planar surface to the first wall or the second wall of the paper package, between the first wall and the second wall, wherein at least part of the heat-sealable or ultrasonically sealable material of the second planar surface constitutes the adhesive stripe of the package, and the longitudinal edge of the tab, facing the inner part of the package, constitutes the fibre rip stopper.

17. The method for making a paper package according to claim 13, wherein the method further comprises:
gluing two tabs of paper or fibre material, the first one onto the first wall of the paper package and the second one onto the second wall of the paper package, wherein the adhesive stripe is formed between the tabs.
